(19) United States
(12) Patent Application Publication
(10) Pub. No.: US 2001/0041151 A1
(43) Pub. Date: Nov. 15, 2001

(54) Device for pyrolysis gas chromatography, a method for analysing polymers using said device, and a pyrolyzator

(75) Inventors: Tadeusz Gorecki, Waterloo (CA); Jurgen Porschmann, Leipzig (DE)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: UFZ-Umweltforschungszentrum Leipiz-Halle GmbH, Leipzig (DE)

(21) Appl. No.: 09/799,652

(22) Filed: Mar. 5, 2001

(30) Foreign Application Priority Data
Mar. 3, 2000 (DE) 1 00 11 901.8

(51) Int. Cl. G01N 30/02

(52) U.S. Cl. 422/89; 422/80

(57) ABSTRACT

The invention relates to a device for pyrolysis gas chromatography, consisting of a carrier gas supply (1), a commercially available gas chromatography (GC) separating capillary (2) and a detector (3), which device is characterized in that upstream of said GC separating capillary (2), a metal capillary (4) connected to a power supply for direct heating is arranged as pyrolyzator and forms an integral part of the carrier gas train, whereby the metal capillary (4) is connected with the GC separating capillary (2) through an interface (6) and the inner diameter of the metal capillary (4) is from 0,32 to 1 mm.

The invention is also directed to a pyrolytic gas-chromatographic method of analysing polymers by detecting without discrimination high-boiling and low-volatilty pyrolysis products.

### SPECIFICATION

The invention relates to a pyrolysis gas chromatography device used in the analysis of polymers by detecting the pyrolyzates thereof, by means of which even high-boiling and low-volatility pyrolysis products can be detected without discrimination and in a reproducible fashion. The invention is also directed to a pyrolytic gas-chromatographic method of analysing polymers by detecting polymer pyrolysis products using said device, and to a pyrolyzator for capillary gas chromatographs to be connected to gas chromatography (GC) separating columns.

Pyrolytic methods, particularly a combination of pyrolysis and gas chromatography with mass-spectrometric detection, have been established for the analytical characterization of polymers, as well as biopolymers and pharmaceuticals, and even microorganisms. One form of analytical pyrolysis that is mostly used is the so-called flash pyrolysis where the sample to be examined is heated abruptly to the desired pyrolysis temperature in a pyrolyzator. The gases liberated by pyrolysis are then passed to a GC column and analyzed in a well-known manner using a detector, mostly by mass spectrometry.

Most of the analytical pyrolyses (typical pyrolysis temperature: about 700° C.-750° C.) are performed in a so-called flash pyrolyzator (Pt) or by using ferromagnetic materials having a defined Curie temperature (Curie point pyrolyzator). Most recently, pyrolyzators using laser- and microwave-based excitation have been increasingly supplied.

A common feature of all the systems known to date is that pyrolyzator and GC column are separated from each other as a result of their design, i.e., the pyrolysis gases normally are transferred from the pyrolyzator into the GC column via a heated interface, said interface connecting the pyrolyzator with the injector of the gas chromatograph.

These commercially supplied systems involve the drawback of suffering from discrimination effects which may give rise to incorrect conclusions as to the structure of the polymers as well as biased quantitative results may occur. In particular, these discrimination effects become apparent in high-boiling compounds. Amongst all of the pyrolyzate components, however, it is low-volatility compounds which provide the most powerful structural information; most of the low-molecular weight compounds in the pyrolyzate, such as carbon dioxide, carbon monoxide, methane, BTX aromatic compounds, etc., have low structural significance.

It was therefore the object of the invention to provide a device and method permitting detection free of discrimination and in a reproducible fashion, particularly of high-boiling and low-volatility compounds. Also, it was the object of the invention to utilize commercially available devices to the largest possible extent and to develop additional components therefor in order to solve the problem of the invention.

The object of the invention is accomplished according to the independent claims. The subclaims represent advantageous embodiments of the invention.

No discrimination effects were found to occur when performing the pyrolysis in a metal capillary 4 upstream of GC separating capillary 2 and connected with the GC separating capillary 2 through an interface 6. That means, the interface 6 is arranged downstream of metal capillary 4 and upstream of GC separating capillary 2. The metal capillary 4 is connected to a power supply 13 for direct heating of the capillary and the inner diameter of the metal capillary 4 is from 0,32 to 1 mm. As GC separating capillary 2 a commercially available capillary of inner diameter of 0,25 or 0,32 mm is used in a preferred embodiment. The method according to the invention completely eliminates losses of pyrolyzate occurring in conventional pyrolysis. The compounds which, according to the invention, are to be determined without discrimination include e.g. humic substances, biopolymers, including lignin, polysaccharides, proteins, nucleic acids; colored pigments, synthetic resins, pharmaceuticals, foodstuffs.

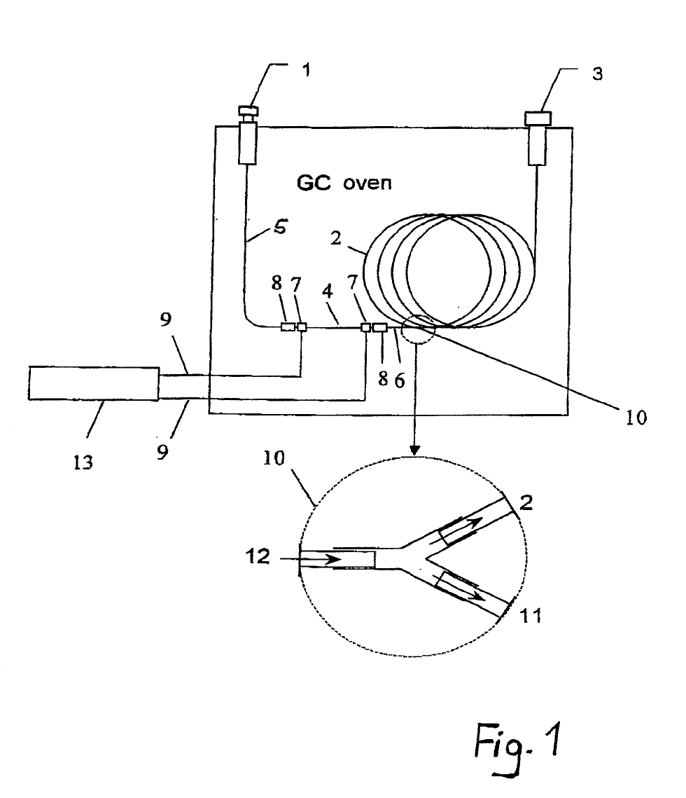

FIG. 1 illustrates the device of the invention in an advantageous embodiment:

1. Carrier gas supply

2. GC separating capillary

3. Detector

4. Metal capillary (pyrolyzator)

5. Restrictor

6. GC column interface

7. Electrical contacts

8. Connector

9. Power supply cables

10. Splitter

11. Split restrictor

12. Carrier gas

13. Power supply

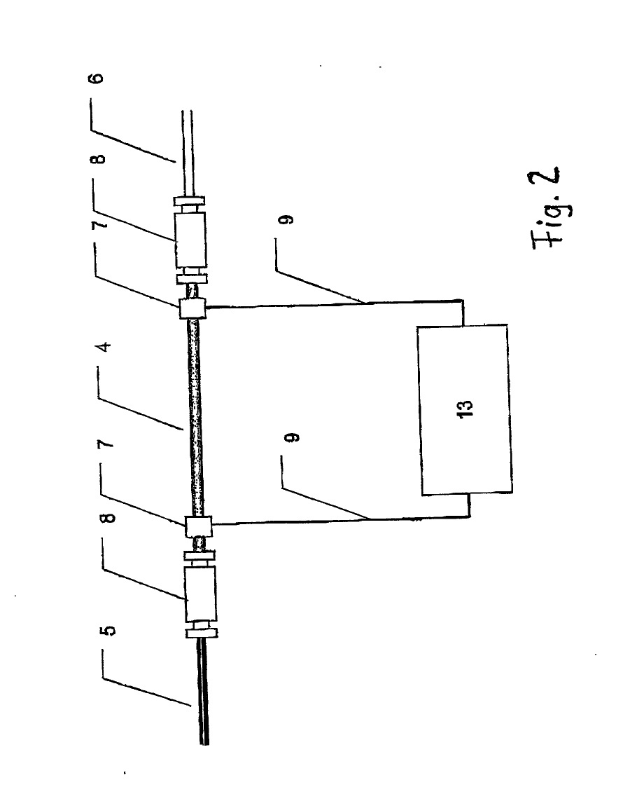

FIG. 2 illustrates an enlarged section of the device according to the invention, comprising restrictor 5, metal pyrolysis capillary 4, and the pyrolysis capillary—GC separating capillary interface 6.

Advantageously, the device illustrated in FIG. 1 is located in the oven of a gas chromatograph, especially the metal capillary 4 together with the GC separating capillary 2 and interface 6. But, of course, it is also possible that the metal capillary 4 which is heated separately and the interface 6 are located outside the GC oven. The sample to be pyrolyzed is placed in the chemically deactivated metal capillary 4 (e.g. SILCOSTEEL by Restek Company). Using special connectors 8 (e.g. Butt Connector from Supelco Co. or Gerstel GmbH), the metal capillary 4, the inner diameter of which preferably is from 0.32 mm to 1 mm and the length of which preferably is 8 m, is connected to a restrictor 5 at the injector (upstream) side. The injector 1 may be of split/splitless, on-column, or PTV (programmed temperature vaporization) typ. The pyrolysis capillary—GC separating capillary interface 6 is connected to the other end of metal capillary 4 via connector 8. The interface 6, preferably in the form of so-called retention gap advantageously made of pure, non-pretreated fused silica, protects the analytical GC separating capillary 2.

The sample is introduced in the metal capillary 4 in the form of a powder or in the form of a highly viscous liquid. Highly viscous liquids frequently occur when the sample to be pyrolyzed has been pretreated with tetramethylammonium hydroxide (TMAH) (e.g. a 25% solution in methanol). This procedure, also referred to as thermochemolysis, is frequently applied in those cases where fatty acid and/or dicarboxylic acid as well as fatty acid alcohol patterns are significant in the polymer to be investigated, because they cannot detected in native form by means of conventional pyrolysis. As is well-known, these polar compounds are subject to a variety of reactions in conventional pyrolysis, e.g. decarboxylation.

The pyrolysis sample is fixed at both ends in metal capillary 4 using sorption-inactive, high temperature-resistant quartz wool.

The restrictor 5 (cf., FIG. 2) is used to prevent back-flow of hot pyrolysis gas into the carrier gas supply 1. Restrictor 5 may have the form of an open capillary, and its inner diameter must be substantially smaller than the inner diameter of the metal capillary 4, interface 6 and GC separating capillary 2. Advantageously, a segment of a 0.1 mm quartz capillary (fused silica) of about 30 cm can be used as restrictor 5. Alternatively, a back-flow valve may also be used as restrictor 5.

The carrier gas preferably is supplied through the carrier gas supply 1 which is an GC injector. However, separate carrier gas supply without a GC injector is also possible.

In case the mass of pyrolysis products should exceed the capacity of GC separating capillary 2 or of detector 3, a splitter 10 can be provided to split the pyrolyzate stream. The outlets of splitter 10 are connected to GC separating capillary 2 and split restrictor 11 which limits the gas flow. The split restrictor 11 preferably is a narrow capillary. The split ratio can be adjusted via the inner diameter of the split capillary and the length thereof, or by means of a needle valve.

Thus, the stream of carrier gas flows from injector 1 or from the carrier gas supply through restrictor 5, metal capillary 4, interface 6 and GC separating capillary 2 to the detector 3. The capillary 4 is heated abruptly, e.g. by using an electric current from a power supply 13, based on e.g. a capacitive discharge. In this event, the pyrolysis temperature can be controlled by adjusting the voltage that charges the capacitor. Alternatively, the real temperature can be measured using a real time display (e.g. through optical fibers), where the current is switched off via feedback to the control unit as soon as the desired pyrolysis temperature is reached.

However, there are other ways of heating the capillary 4. For example, the capillary 4 could also be made of a ferromagnetic material and heated via induction. In this event, the pyrolysis temperature could be controlled via the Curie point of the ferromagnetic material. Another possibility is to use a capillary 4 made of a transparent material and heat this material (including the introduced pyrolysis sample) by a strong pulse of radiation (microwave, infrared, ultraviolet, visible region).

Following pyrolysis, it is recommendable to maintain the metal capillary 4 at the elevated temperature. This is ensured by a controlled electric current flowing through metal capillary 4, or by means of an external source of heat, e.g. a heating jacket made of steel. In particular, such post-heating is necessary in those cases where the pyrolysis sample yields a solid residue after pyrolysis (for example, humic substances yield a charcoal-like residue) and this residue is capable of discriminating high-boiling/polar compounds as a result of its high sorptive capacity.

The metal capillary 4 is disposable. It is recommendable to replace it after each pyrolysis, because artefacts might occur in repeated use.

When using a capacitive discharge as a power supply of metal capillary 4, the latter was found to be heated to the desired pyrolysis temperature of e.g. 750° C. within a range of milliseconds. The temperature distribution in the metal capillary 4 of the invention is very favorable. The maximum temperature is reached immediately along the entire length of the capillary virtually at the same time.

Thus, the device according to the invention is a capillary column chromatograph for pyrolysis gas chromatography, wherein the pyrolyzator and GC separating capillary 2 are connected in-line through an interface, the pyrolyzator being a metal capillary 4. The capillary is heated abruptly, preferably by passing an electric current through capillary 4, said current being derived from the discharge of a large capacitor or a set of capacitors. The pyrolysis temperature is controlled by adjusting the voltage that charges the capacitor, or by measuring the temperature of pyrolysis capillary 4 and appropriately adjusting the electric current as the pyrolysis temperature is reached. Preferably, the pyrolysis capillary 4 is situated within the oven of the gas chromatograph, together with GC separating capillary 2 and precolumn 6.

In a further preferred embodiment of the invention the interface 6 may be an GC injector which acts as an interface connecting capillary 4 and GC column 2, whereby pyrolysis capillary 4 and injector 6 are arranged outside the GC oven. In this embodiment the capillary 4 is inserted into GC injector 6 which is kept at high temperature from 350 to 420° C., preferably at about 380° C., and the pyrolysis is immediately carried out. This embodiment has the advantage that the metal capillary 4 may be changed very easily by removing it from and sliding it in the opening of the injector 6.

In an especially preferred embodiment it is also possible that a precolumn 6 is arranged downstream of injector 6 and upstream of GC separating capillary 2. That means, the interface 6 consists of an injector acting as an interface and a precolumn.

The invention is also directed to a pyrolyzator for capillary gas chromatographs, which pyrolyzator is to be connected to the GC separating capillary 2 through the uptstream interface (precolumn) 6 and—as described above—consists of a metal capillary 4, the metal capillary 4 being provided with contacts for a power supply and optionally enveloped by a heatable jacket. The pyrolyzator capillary 4 preferably has a diameter of from 0.32 to 1 mm and a length of from 4 to 20 cm, preferably 8 cm.

The inventive pyrolytic gas-chromatographic method of analysing polymers by detecting without discrimination pyrolysis products of these polymers, preferably high-boiling and low-volatility pyrolysis products, is characterized in that an aliquot of the sample to be examined is abruptly heated to the pyrolysis temperature in a pyrolyzator, and the gases liberated by pyrolysis are passed into a GC separating capillary connected to a detector, wherein a device according to the invention is used including the pyrolyzator metal capillary 4 as an in-line component of the GC carrier gas system, and the sample to be examined is pyrolyzed in the metal capillary 4 at the desired temperature, and the pyrolysis gases are passed into the GC separating capillary 2 through interface 6 by means of the carrier gas stream under forced flow conditions. According to the invention the carrier gas flows through the sample to be pyrolized with a high speed (approximately with a speed larger than 10 cm/s) carrying the pyrolysis gases away and thus preventing a resorption of these gases on a possible solid pyrolysis residue with high sorption capabilities. These forced flow conditions are achieved with the metal capillary 4 of the invention which has an inner diameter from 0,32 to 1 mm, preferably of 0,53 mm, and is heated directly.

Without intending to be limiting, the invention will be illustrated in more detail below with reference to the embodiments.

### EXAMPLE 1

Comparison of Conventional Pyrolysis with the Method of the Invention in the Case of Alkylbenzenes

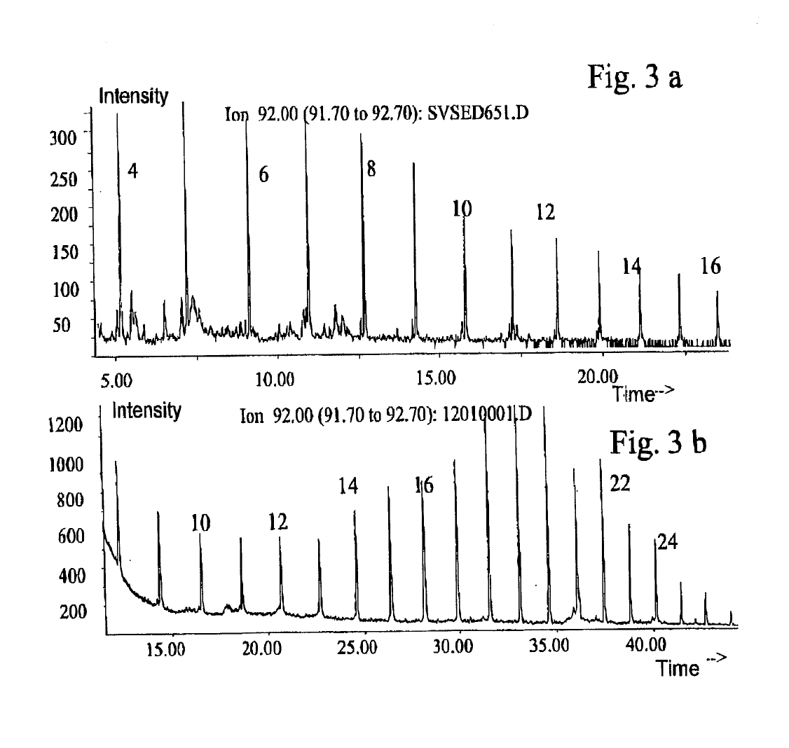

When pyrolyzing soils/sediments having undergone anthropogenic influence (e.g., including mineral oils and waste waters from the brown coal industry), higher alkane and alkylbenzene homologues cannot be detected or only in a discriminated form when using conventional pyrolyzator GC systems, e.g. a CDS 1000. This may give rise to incorrect conclusions as to contamination or decontamination. FIG. 3a shows the discrimination in conventional pyrolysis in the case of alkylbenzenes. The numeral “4” in FIG. 3a indicates that this is n-butylbenzene, “6” is n-hexylbenzene, and so on. FIG. 3b shows that higher alkane and alkylbenzene homologues can be detected without discrimination when using the detection method according to the invention.

### EXAMPLE 2

Comparison of Conventional and Inventive Pyrolysis, Illustrated on the Example of Thermochemolysis using Tetramethylammonium Hydroxide, for the Determination of the Fatty Acid Profile of a Humic Substance Sample Isolated from Natural Peat, using Fatty Acid Methyl Esters

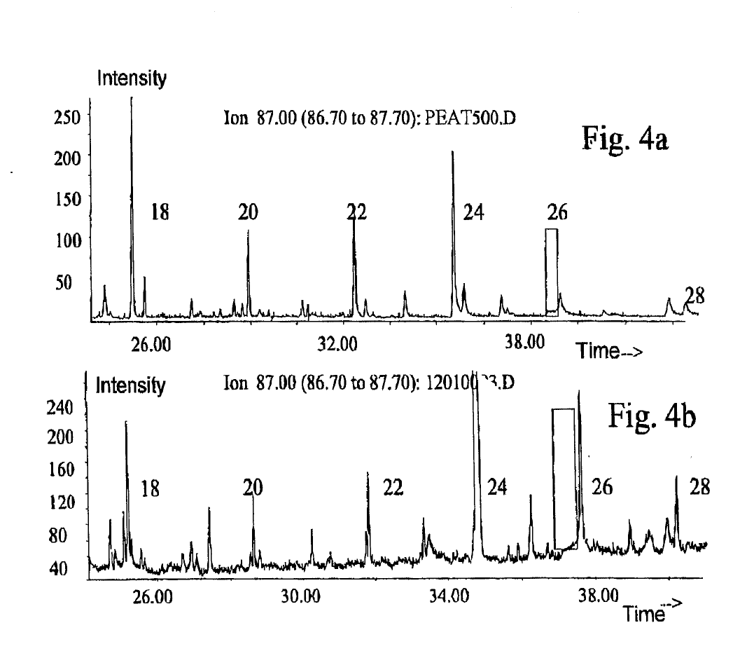

Fatty acid methyl esters formed following thermochemolysis with tetramethylammonium hydroxide are subject to significant discrimination in the range C>18 (similarly, this applies for dicarboxylic acid methyl esters even in a lower C interval) when using the conventional method (see FIG. 4a).

FIG. 4b shows the fatty acid profile obtained according to the invention in a non-discriminated form. While e.g. stearic acid methyl ester in the conventional procedure (designated “18” in FIGS. 4a and 4b) appears with a higher ratio in the pyrogram compared to lignoceric acid methyl ester (designated “24”) which is subject to significant discrimination, the peak of the methyl ester with lower volatility is substantially larger than the peak of stearic acid methyl ester in the in-column pyrolysis according to the invention. Despite their significant appearance as a result of thermochemolysis, the C₂₆ and C₂₈ fatty acid methyl esters are barely detected in the conventional procedure. The fatty acid methyl esters were detected by extracting the selective ion at m/z=87 amu.

### EXAMPLE 3

Detection of Wax Esters

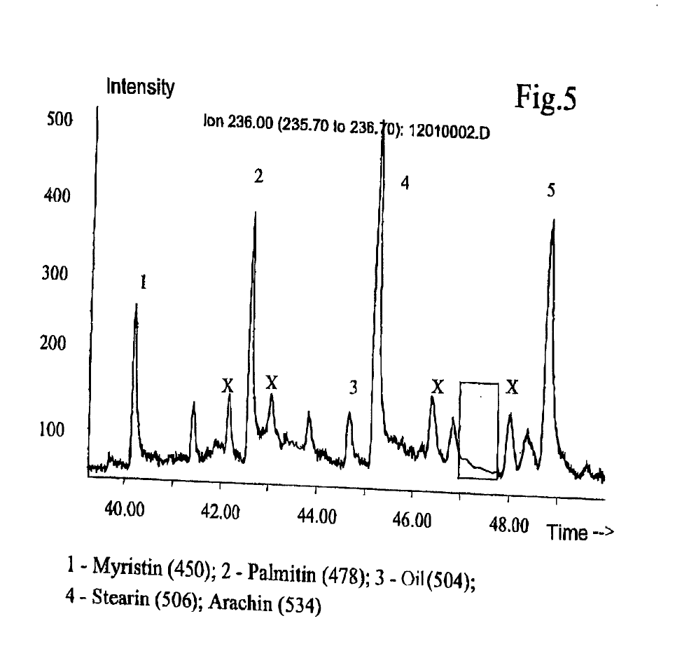

The detection of wax esters with conventional pyrolysis configurations has not been possible to date. Due to their discrimination, they nearly or completely disappear in the detector noise, even when using the highly sensitive SIM technology (single ion monitoring). FIG. 5 shows that these high-boiling compounds within the C interval of C₃₀-C₃₆ can be detected easily when using the method according to the invention. FIG. 5 shows the profile of the extracted ion m/z=236 amu, indicative of palmitoleic acid methyl ester. The designation “stearin (478)” in FIG. 5 indicates that this is an alcohol residue having 18 C atoms and the molecular weight of the ester having m.w.=506 D (similarly for myristin, palmitin and arachin residues, see FIG. 5). The peaks designated “X” in FIG. 5 represent compounds which likewise undergo fragmentation at the selected ion m/z=236 D but are not wax esters.

### EXAMPLE 4

Detection of Hopanoic Acids and Hopanols in Peat-derived Humic Substance using TMAH-induced Thermochemolysis

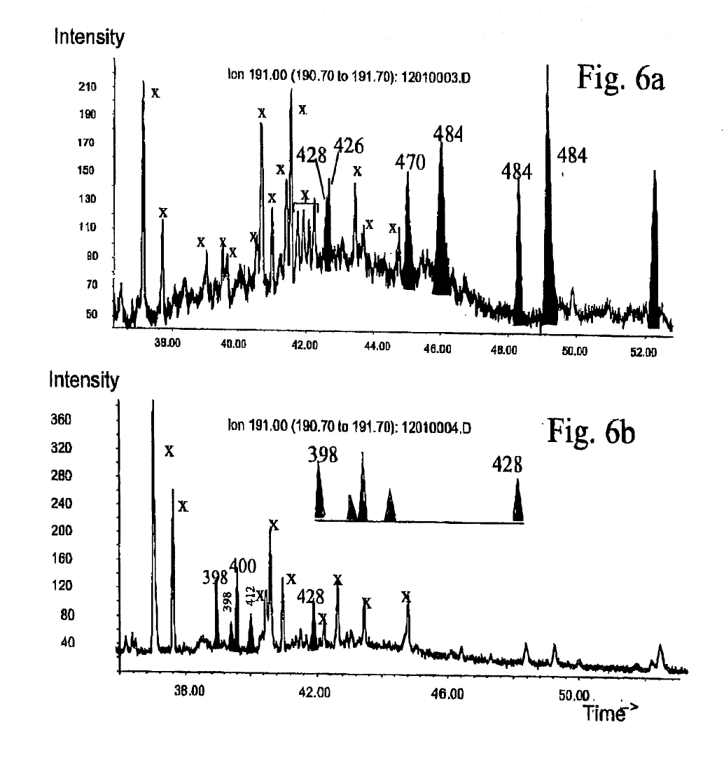

Using the method according to the invention (in this specific case, use of thermochemolysis with TMAH), it was possible for the first time to detect hopanoic acids in humic substances unambiguously by means of pyrolysis (cf., FIG. 6a). At a pyrolysis/thermochemolysis temperature of 500° C., the ester bonds in the polymeric humic substance molecule undergo cleavage, and the liberated acids are detected in the form of their methyl esters (molecular weights of the detected methyl esters: 426, 428, 470, and 484 D; see FIG. 6a). Cleavage of the ether bonds takes place only at elevated pyrolysis temperatures of e.g. 750° C., i.e., hopanols in the form of methoxy compounds will only be detected in this second pyrolysis step (FIG. 6b).

When using a CDS pyrolyzator, it was not possible to detect these compounds, although they had been formed during pyrolysis/thermochemolysis. The target analytes in FIG. 6a and 6b completely disappear in the detector noise. Even with increased initial weights of pyrolysis material, no significant mass spectra can be obtained (however, the humic substance initial weight should always be adapted to the capacity of the GC separating column).

### EXAMPLE 5

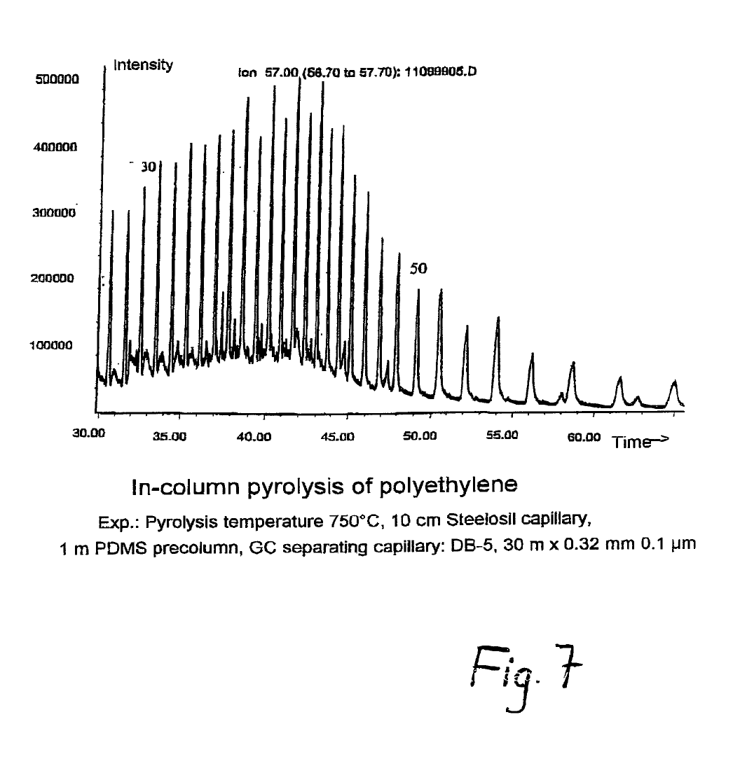

FIG. 7 shows the pyrogram of a polyethylene in-column pyrolysis according to the invention. As can clearly be seen, the C number range of C₅₀ is detectable without discrimination (when using a higher resolution of the separating capillary, each peak is split into alkanes/1-alkenes and alkadienes). A HP-5 capillary, 30 m×0.32 mm, film thickness 0.25 μm, was used; the final temperature was 325° C., constant flow rate of carrier gas.

In conventional pyrolysis operation, significant discrimination already occurs in the C interval of C₂₀.

claims:

1. A device for pyrolysis gas chromatography, consisting of a carrier gas supply (1), a gas chromatography (GC) separating capillary (2) and a detector (3), wherein upstream of said GC separating capillary (2), a metal capillary (4) is arranged as pyrolyzator and forms as an in-line configuration an integral part of the carrier gas train, whereby the metal capillary (4) is connected with the GC separating capillary (2) through an interface (6) and the inner diameter of the metal capillary (4) is from 0,32 to 1 mm and the metal capillary (4) is connected to a power supply (13) for its direct heating.

2. The device according to claim 1, wherein a restrictor (5) is arranged between carrier gas supply (1) and metal capillary (4), whereby the restrictor (5) is a capillary more narrow than metal capillary (4), or represents a valve or a constriction of the corresponding end of metal capillary (4).

3. The device according to claim 1, wherein the interface (6) is a precolumn to remove interfering pyrolysis byproducts or an injector connecting capillary (4) and GC seperating capillary (2), preferably the interface (6) consists of an injector arranged downstream of capillary (4) and a precolumn arranged downstream of injector (6) and upstream of GC capillary (2).

4. The device according to claim 1, wherein a splitter (10) is arranged between interface (6) and GC separating capillary (2), the outlets of said splitter being connected with GC separating capillary (2) and with a split restrictor (11).

5. The device according to claim 1, wherein the carrier gas supply (1) is an on-column injector, a split or spitless injector, or a PTV injector.

6. The device according to claim 1, wherein the detector (3) is a mass spectrometer.

7. The device according to claim 1, wherein the metal capillary (4) is made of a chemically deactivated metal, preferably of steel.

8. The device according to claim 1, wherein the metal capillary (4) is situated in the gas chromatography oven together with GC separating capillary (2) and interface (6).

9. The device according to claim 1, wherein the power supply of metal capillary (4) is based on the discharge of a large capacitor or a set of capacitors.

10. The device according to claim 1, wherein the metal capillary (4) has an inner diameter of 0,53 mm.

11. The device according to claim 1, wherein the GC separating capillary (2) has an inner diameter of 0,25 or 0,32 mm.

12. A pyrolytic gas-chromatographic method of analysing polymers by detecting without discrimination the pyrolysis products of these polymers, wherein an aliquot of the sample to be examined is abruptly heated to the pyrolysis temperature in a pyrolyzator, and the gases liberated by pyrolysis are passed into a GC separating capillary connected to a detector, wherein a device according to claims 1 to 11 is used, including the pyrolyzator metal capillary (4) as an in-line component of the GC carrier gas system, and the sample to be examined is pyrolyzed in the metal capillary (4) at the desired temperature, and the pyrolysis gases are passed into the GC separating capillary (2) through interface (6) by means of the carrier gas stream under forced flow conditions.

13. The method according to claim 12, wherein high-boiling and low-volatility pyrolysis products are detected.

14. The method according to claim 12, characterized in that the power supply of metal capillary (4) is achieved by means of a capacitive discharge.

15. A pyrolyzator for capillary gas chromatographs, intended to be connected to a GC separating capillary (2) through an interface (6) arranged upstream, which pyrolyzator consists of a metal capillary (4) provided with contacts to the power supply for direct heating of the metal capillary (4), wherein the inner diameter of the metal capillary (4) is from 0,32 to 1 mm, preferably 0,53 mm.

16. The pyrolyzator according to claim 15, wherein the length of the metal capillary (4) is from 4 to 20 cm, preferably 8 cm.
